(19) United States
(12) Patent Application Publication
(10) Pub. No.: US 2017/0280479 A1
(43) Pub. Date: Sep. 28, 2017

(54) RADIO ACCESS NODE, COMMUNICATION TERMINAL AND METHODS PERFORMED THEREIN

(71) Applicant: Telefonaktiebolaget LM Ericsson (publ), Stockholm (SE)

(72) Inventors: Mattias Frenne, Uppsala (SE); Jung-Fu Cheng, Fremont, CA (US); Daniel Larsson, Stockholm (SE); Havish Koorapaty, Saratoga, CA (US); Sorour Falahati, Stockholm (SE)

(21) Appl. No.: 15/509,001

(22) PCT Filed: Sep. 10, 2015
(86) PCT No.: PCT/SE2015/050953

§ 371 Date: Mar. 6, 2017

Related U.S. Application Data
(60) Provisional application No. 62/048,448, filed on Sep. 10, 2014.

(51) Int. Cl. H04W 74/08; H04W 24/08; H04W 72/12; H04W 72/04; H04W 48/16; H04W 28/18; H04W 16/14; H04W 48/08

(52) U.S. Cl. CPC H04W 74/0808; H04W 16/14; H04W 24/08; H04W 48/08; H04W 72/0446; H04W 48/16; H04W 28/18; H04W 72/1278

(57) ABSTRACT

A radio access node serves the communication terminal in at least one of a first cell on a carrier of a licensed or unlicensed spectrum, and/or a second cell on a carrier of an unlicensed spectrum. The radio access node determines whether a Listen Before Talk, LBT, process is to be performed or not in the second cell. The radio access node schedules, based on whether the LBT process is to be performed in a subframe on the second cell or not, a control channel and/or a data channel with a start position in the subframe out of at least two start positions. The radio access node transmits control information on the control channel and/or data on the data channel as scheduled to the communication terminal.

### TECHNICAL FIELD

Embodiments herein relate to a radio access node, a communication terminal and methods performed therein. In particular embodiments herein relate to scheduling a control channel and/or a data channel to a communication terminal.

### BACKGROUND

In a typical wireless communication network, communication terminals, also known as wireless devices and/or user equipments (UEs), communicate via a Radio Access Network (RAN) to one or more core networks. The RAN covers a geographical area which is divided into cell areas, with each cell area being served by a radio access node such as a base station, e.g., a radio base station (RBS), which in some networks may also be called, for example, a “NodeB” or “eNodeB”. A cell is a geographical area where radio coverage is provided by the radio base station at a base station site or an antenna site in case the antenna and the radio base station are not co-located. Each cell is identified by an identity within the local radio area, which is broadcast in the cell. Another identity identifying the cell uniquely in the whole wireless communication network is also broadcasted in the cell. One radio access node may have one or more cells. The radio access nodes communicate over the air interface operating on radio frequencies with the communication terminals within range of the radio access nodes with downlink transmissions towards the communication terminals and uplink transmission from the communication terminals.

A Universal Mobile Telecommunications System (UMTS) is a third generation wireless communication system, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for wireless devices. In a forum known as the Third Generation Partnership Project (3GPP), telecommunications suppliers propose and agree upon standards for third generation networks and UTRAN specifically, and investigate enhanced data rate and radio capacity. In some versions of the RAN as e.g. in UMTS, several radio access nodes may be connected, e.g., by landlines or microwave, to a controller node, such as a radio network controller (RNC) or a base station controller (BSC), which supervises and coordinates various activities of the plural base stations connected thereto. The RNCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio access nodes are directly connected to the EPC core network rather than to RNCs. In general, in E-UTRAN/LTE the functions of a RNC are distributed between the radio access nodes, e.g. eNodeBs in LTE, and the core network. As such, the Radio Access Network (RAN) of an EPS has an essentially “flat” architecture comprising radio access nodes without reporting to RNCs.

The 3GPP initiative “License Assisted Access” (LAA) aims to allow LTE equipment to operate in an unlicensed 5 GHz radio spectrum. The unlicensed 5 GHz spectrum is used as an extension to the licensed spectrum. Accordingly, communication terminals connect in the licensed spectrum to a primary cell (PCell), and use carrier aggregation to benefit from additional transmission capacity in the unlicensed spectrum in a secondary cell (SCell). To reduce the changes required for aggregating licensed and unlicensed spectrum, an LTE frame timing in the primary cell is simultaneously used in the secondary cell.

Regulatory requirements, however, may not permit transmissions in the unlicensed spectrum without prior channel sensing. Since the unlicensed spectrum must be shared with other radios of similar or dissimilar wireless technologies, a so called Listen-Before-Talk (LBT) method needs to be applied. Today, the unlicensed 5 GHz spectrum is mainly used by communication terminals implementing the IEEE 802.11 Wireless Local Area Network (WLAN) standard. This standard is known under its marketing brand “Wi-Fi.”

IEEE 802.11 equipment, also called WLAN equipment, uses a contention based medium access scheme. This scheme does not allow a wireless medium to be reserved at specific instances of time. Instead, IEEE 802.11 equipment or IEEE 802.11 compliant devices only support the immediate reservation of the wireless medium following the transmission of at least one medium reservation message, e.g. Request to Send (RTS) or Clear to Send (CTS) or others. To allow the Licensed Assisted (LA)-LTE frame in the secondary cell to be transmitted at recurring time intervals that are mandated by the LTE frame in the primary cell, the LAA system transmits at least one of the aforementioned medium reservation messages to block surrounding IEEE 802.11 equipment from accessing the wireless medium.

LTE uses Orthogonal Frequency-Division Multiplexing (OFDM) in the downlink (DL) and Discrete Fourier Transform (DFT)-spread OFDM in the uplink (UL). A basic LTE downlink physical resource may thus be seen as a time-frequency grid as illustrated in FIG. 1, where each Resource Element (RE) corresponds to one OFDM subcarrier during one OFDM symbol interval. A symbol interval comprises a cyclic prefix (cp), which cp is a prefixing of a symbol with a repetition of the end of the symbol to act as a guard band between symbols and/or facilitate frequency domain processing. Frequencies f or subcarriers having a subcarrier spacing Of are defined along an z-axis and symbols are defined along an x-axis.

In the time domain, LTE downlink transmissions are organized into radio frames of 10 ms, each radio frame comprising ten equally-sized subframes denoted #0 -#9, each with a T_{subframe}=1 ms of length in time as shown in FIG. 2. Furthermore, the resource allocation in LTE is typically described in terms of resource blocks, where a resource block corresponds to one slot of 0.5 ms in the time domain and 12 subcarriers in the frequency domain. A pair of two adjacent resource blocks in time direction covering 1.0 ms, is known as a resource block pair. Resource blocks are numbered in the frequency domain, starting with resource block 0 from one end of the system bandwidth. For normal cyclic prefix, one subframe consists of 14 OFDM symbols. The duration of each OFDM symbol is approximately 71.4 μs.

Downlink and uplink transmissions are dynamically scheduled, i.e. in each subframe the radio access node transmits control information about to or from which communication terminal data is transmitted and upon which resource blocks the data is transmitted, in the current downlink subframe. The control information for a given communication terminal is transmitted using one or multiple Physical Downlink Control Channels (PDCCH), and this control signaling is typically transmitted in one or more of the first OFDM symbols, e.g. 1, 2, 3 or 4 OFDM symbols covering a control region, in each subframe and the number n=1, 2, 3 or 4 is known as the Control Format Indicator (CFI). Typically the control region may comprise many PDCCH carrying control information to multiple communication terminals simultaneously. A downlink system with 3 OFDM symbols allocated for control signaling, for example the PDCCH, is illustrated in FIG. 3 and which three OFDM symbols form a control region. The resource elements used for control signaling are indicated with wave-formed lines and resource elements used for reference symbols are indicated with diagonal lines. Frequencies f or subcarriers are defined along a z-axis and symbols are defined along an x-axis. The downlink subframe also contains common reference symbols, which are known to the receiver and used for channel estimation for coherent demodulation of e.g. the control information. A downlink system with CFI=3 OFDM symbols as control region is illustrated in FIG. 3.

From LTE Rel-11 onwards above described resource assignments can also be scheduled on the enhanced Physical Downlink Control Channel (EPDCCH). For Rel-8 to Rel-10 only PDCCH is available.

The reference symbols shown in the FIG. 3 are the Cell specific Reference Symbols (CRS) and are used to support multiple functions including fine time and frequency synchronization and channel estimation for certain transmission modes.

In a wireless communication network there is a need to measure the channel conditions in order to know what transmission parameters to use. These parameters include, e.g., modulation type, coding rate, transmission rank, and frequency allocation. This applies to uplink (UL) as well as downlink (DL) transmissions.

The scheduler that makes the decisions on the transmission parameters is typically located in the radio access node e.g. the base station (eNB). Hence, the radio access node can measure channel properties of the UL directly using known reference signals that the communication terminals transmit. These measurements then form a basis for the UL scheduling decisions that the radio access node makes, which are then sent to the communication terminals via a downlink control channel.

However, for the DL the radio access node is unable to measure any channel parameters. Rather, it must rely on information that the communication terminals may gather and subsequently send back to the radio access node. This so-called Channel-State Information (CSI) is obtained in the communication terminals by measuring on known reference symbols e.g. Channel-State Information Reference Symbols (CSI-RS), transmitted in the DL. See ref. 36.211 section 6.10.5 version 12.2.0, which pertains to LTE specifically.

The PDCCH/EPDCCH is used to carry Downlink Control Information (DCI) in a scheduling DCI message such as scheduling decisions and power-control commands.

More specifically, the DCI comprises:

Downlink scheduling assignments, including Physical Downlink Shared Channel (PDSCH) resource indication, transport format, Hybrid-Automatic Repeat Request (HARQ) information, and control information related to spatial multiplexing, if applicable. A downlink scheduling assignment also includes a command for power control of the Physical Uplink Control Channel (PUCCH) used for transmission of HARQ acknowledgements (ACK) in response to downlink scheduling assignments.

Uplink scheduling grants, including Physical Uplink Shared Channel (PUSCH) resource indication, transport format, and HARQ-related information. An uplink scheduling grant also includes a command for power control of the PUSCH.

Power-control commands for a set of communication terminals as a complement to the commands included in the scheduling assignments/grants.

One PDCCH/EPDCCH carries one DCI message containing one of the groups of information listed above. As multiple communication terminals may be scheduled simultaneously, and each communication terminal can be scheduled on both downlink and uplink simultaneously, there must be a possibility to transmit multiple scheduling messages within each subframe. Each scheduling message is transmitted on separate PDCCH/EPDCCH resources, and consequently there are typically multiple simultaneous PDCCH/EPDCCH transmissions within each subframe in each cell. Furthermore, to support different radio-channel conditions, link adaptation may be used, where the code rate of the PDCCH/EPDCCH is selected by adapting the resource usage for the PDCCH/EPDCCH, to match the radio-channel conditions.

Here follows a discussion on a starting OFDM symbol for PDSCH and EPDCCH within the subframe. The OFDM symbols in a first slot are numbered from 0 to 6.

For transmissions modes 1-9, the starting OFDM symbol in the first slot of the subframe for EPDCCH can be configured by higher layer signaling and the same starting OFDM symbol is in this case used for the corresponding scheduled PDSCH. Both sets have the same EPDCCH starting symbol for these transmission modes. If not configured by higher layers, the starting OFDM symbol for both PDSCH and EPDCCH is given by the CFI value signaled in Physical Control Format Indicator Channel (PCFICH).

Multiple starting OFDM symbol candidates may be achieved by configuring the communication terminal in transmission mode 10, by having multiple EPDCCH Physical Resource Block (PRB) configuration sets where for each set the starting OFDM symbol in the first slot in a subframe for EPDCCH can be configured by higher layers to be a value from {1,2,3,4}, independently for each EPDCCH set. If a set is not higher layer configured to have a fixed starting OFDM symbol, then the EPDCCH starting OFDM symbol for this set follows the CFI value received in PCFICH.

For transmission mode 10 and when receiving DCI format 2D, the starting OFDM symbol in the first slot of a subframe for PDSCH is dynamically signaled in the DCI message to the communication terminal using two “PDSCH Resource Element (RE) Mapping and Quasi Co-Located Indicator”, PQI for short, bits in the DCI format 2D. Up to four possible OFDM start values is thus possible to signal to the communication terminal and the OFDM start values may be taken from the set {1,2,3,4}. Which OFDM start value each of the four states of the PQI bits represents, is configured by Radio Resource Control (RRC) signaling to the communication terminal. For example, it is possible that e.g. PQI=″00″ and PQI=″01″ represent PDSCH start symbol 1 and PQI=″10″ and PQI=″11″ represents PDSCH start symbol 2. It is also possible to assign a PQI state or PQI value, e.g. “00”, to indicate that the value CFI in the PCFICH should be used for PDSCH start symbol assignment.

Moreover, in transmission mode 10, when EPDCCH is configured and when DCI format 2D is received, the starting OFDM symbol for each of the two EPDCCH sets re-use the PDSCH start symbol of a PQI state configured for PDSCH to the communication terminal. Note that these EPDCCH start symbols are not dynamically varying, in which case they would have been varying from subframe to subframe, but are semi-statically configured by higher layer signaling, and taken from the higher layer configured parameters related to the PQI states. For example, if PQI=“00” and PQI=“01” represent PDSCH start symbol 1 and PQI=“10” and PQI=“11” represent PDSCH start symbol 2, then EPDCCH set 1 and 2 can only start at either OFDM symbol 1 or 2 in this example since these are the start values used for PDSCH. Which one is used for each EPDCCH set is also conveyed by RRC signaling to the communication terminal when configuring the EPDCCH parameters. For example EPDCCH set 1 use start symbol 1 and EPDCCH set 2 use start symbol 2 in this non-limiting example. Note that the start symbols for each EPDCCH set is fixed until it is re-configured in a RRC re-configuration whereas a PDSCH scheduled from any of the two EPDCCH sets can be signaled dynamically to start at either symbol 1 or 2, using the PQI bits.

The LTE Rel-10 standard supports bandwidths larger than 20 MHz being a licensed spectrum. One important requirement on LTE Rel-10 is to assure backward compatibility with LTE Rel-8. This should also include spectrum compatibility. That would imply that an LTE Rel-10 carrier, wider than 20 MHz, should appear as a number of LTE carriers to an LTE Rel-8 terminal. Each such carrier can be referred to as a Component Carrier (CC). In particular for early LTE Rel-10 deployments it can be expected that there will be a smaller number of LTE Rel-10-capable communication terminals compared to many LTE legacy communication terminals. Therefore, it is necessary to assure an efficient use of a wide carrier also for legacy communication terminals, i.e. that it is possible to implement carriers where legacy communication terminals may be scheduled in all parts of the wideband LTE Rel-10 carrier. The straightforward way to obtain this would be by means of Carrier Aggregation (CA). CA implies that an LTE Rel-10 communication terminal may receive multiple CC, where the CC have, or at least has the possibility to have, the same structure as a Rel-8 carrier. CA is illustrated in FIG. 4.

The number of aggregated CC as well as the bandwidth of the individual CC may be different for uplink and downlink. A symmetric configuration refers to the case where the number of CCs in downlink and uplink is the same whereas an asymmetric configuration refers to the case where the number of CCs is different between UL and DL. It is important to note that the number of CCs configured in a cell may be different from the number of CCs seen by a communication terminal. For example, a communication terminal may support more downlink CCs than uplink CCs, even though the cell is configured with the same number of uplink and downlink CCs.

Scheduling of a CC is done on the PDCCH or EPDCCH via downlink assignments. Control information on the PDCCH/EPDCCH is formatted as a Downlink Control Information (DCI) message. In Rel-8 a communication terminal only operates with one DL and one UL CC. The association between DL assignment, UL grants and the corresponding DL and UL CCs is therefore clear. In Rel-10 two modes of CA needs to be distinguished. A first case is very similar to the operation of multiple Rel-8 communication terminals; a DL assignment or UL grant contained in a DCI message transmitted on a CC is either valid for the DL CC itself or for an associated, either via cell-specific or communication terminal specific linking, UL CC. A second mode of operation, denoted cross-carrier scheduling, augments a DCI message with a Carrier Indicator Field (CIF). A DCI message containing a DL assignment with CIF is valid for the indicated DL CC and a DCI message containing an UL grant with CIF is valid for the indicated UL CC. The DCI message transmitted using EPDCCH which was introduced in Rel-11 can also carry CIF which means that cross-carrier scheduling is supported also when using EPDCCH.

In typical deployments of WLAN, Carrier Sense Multiple Access with Collision Avoidance (CSMA/CA) is used. This means that the channel is sensed, and only if the channel is declared as Idle, a transmission is initiated. In case the channel is declared as Busy, the transmission is essentially deferred until the channel is found Idle. When the range of several radio access nodes using the same frequency overlap, this means that all transmissions related to one radio access node might be deferred in case a transmission on the same frequency to or from another radio access node which is within range can be detected. Effectively, this means that if several radio access nodes are within range, they will have to share the channel in time, and the throughput for the individual radio access nodes may be severely degraded. An illustration of an example of an LBT mechanism is shown in FIG. 5. During a first time interval T₁ the radio access node performs Clear Channel Assessment (CCA) using energy detection of a wireless channel. Traffic is not detected during the first time interval T₁, T₁≧20 μs. The radio access node then occupies the wireless channel and starts data transmission over a second time interval T₂. The second time interval may be in the range of 1 ms to 10 ms. The radio access node may then send control (CTRL) signals without performing a CCA check over a fifth time interval T₅ because the channel has already been occupied by the radio access node for the data transmission. Then during a time period T₃ of length ≧0.05 T₂, the radio access node remains idle, meaning that the radio access node does not transmit on the wireless channel. At the end of the Idle period, the radio access node performs CCA and detects that the channel is being used for other traffic. Then during a fourth time interval T₄ being defined as T₂+T₃ the radio access node is prohibited to transmit on the wireless channel, as it was found to be occupied by other traffic. The radio access node starts a CCA at the end of the prohibited time T₄. The radio access node performs CCA using energy detection at the end of the fourth time interval T₄. As the CCA indicates that the wireless channel is free, the radio access node may occupy the channel and start a data transmission.

Up to now, the spectrum used by LTE is dedicated to LTE. This has the advantage that LTE system does not need to care about the coexistence issue and the spectrum efficiency can be maximized. However, the spectrum allocated to LTE is limited which cannot meet the ever increasing demand for larger throughput from applications/services. Therefore, discussions are ongoing in 3GPP to initiate a new study item on extending LTE to exploit unlicensed spectrum in addition to licensed spectrum. Unlicensed spectrum can, by definition, be simultaneously used by multiple different technologies. Therefore, LTE needs to consider the coexistence issue with other systems such as IEEE 802.11 (Wi-Fi). Operating LTE in the same manner in unlicensed spectrum as in licensed spectrum can seriously degrade the performance of Wi-Fi as Wi-Fi will not transmit once it detects that the channel is occupied.

Furthermore, one way to utilize the unlicensed spectrum reliably is to transmit essential control signals and channels on a licensed carrier. That is, as shown in FIG. 6, a communication terminal is connected to a PCell in the licensed band or spectrum and one or more SCells in the unlicensed band or spectrum. A secondary cell in unlicensed spectrum is herein denoted as license assisted secondary cell (LA SCell).

Prior to occupying a channel in an unlicensed band, the network needs to check the availability of the channel by means of LBT. When the network has already accessed a channel, it may, in the following and adjacent transmission time interval, start transmission immediately, e.g. from symbol 0, without performing LBT.

Whether LBT is used in a subframe is a network, or radio access node, decision. It is thus a problem how the communication terminal will know whether the radio access node is performing LBT or not, since it impacts the mapping of EPDCCH and PDSCH modulated symbols to resource elements. If the start symbol is unknown, the communication terminal is unable to receive messages. For example, when the radio access node is performing LBT and is not transmitting anything, the communication terminal may expect to receive EPDCCH and try to monitor EPDCCH although the radio access node is performing LBT and not transmitting anything. This would result in a decoding failure and unnecessary power consumption at the communication terminal and inefficient transmission at the radio access node. This will lead to a limited performance of the wireless communications network.

### SUMMARY

An object of embodiments herein is to provide a mechanism to improve the performance of a wireless communications network implementing usage of a telecommunication technology into an unlicensed spectrum where e.g. LBT is used.

The object is achieved by providing a method performed by a radio access node for scheduling a control channel and/or a data channel to a communication terminal in a wireless communication network. The radio access node serves the communication terminal in at least one of a first cell on a carrier of a licensed or unlicensed spectrum, and/or a second cell on a carrier of an unlicensed spectrum. The radio access node determines whether an LBT process is to be performed or not in the second cell. The radio access node schedules, based on whether the LBT process is to be performed in a subframe on the second cell or not, a control channel and/or a data channel with a start position in the subframe out of at least two start positions. The radio access node then transmits control information on the control channel and/or data on the data channel as scheduled to the communication terminal.

The object is further achieved by providing a method performed by a communication terminal for handling communication in a wireless communication network, wherein the communication terminal is configured to communicate with a radio access node in a first cell on a carrier of a licensed or unlicensed spectrum and/or a second cell on a carrier of an unlicensed spectrum. The communication terminal receives a configuration from the radio access node, which configuration defines that the communication terminal is to monitor at least two start positions for a control channel intended for the communication terminal. The communication terminal then monitors the at least two start positions for reception of the control channel.

Furthermore, the object is achieved by providing a radio access node for scheduling a control channel and/or a data channel to a communication terminal in a wireless communication network. The radio access node is configured to serve the communication terminal in at least one of a first cell on a carrier of a licensed or unlicensed spectrum, and/or a second cell on a carrier of an unlicensed spectrum. The radio access node is further configured to determine whether an LBT process is to be performed or not in the second cell. The radio access node is also configured to schedule, based on whether the LBT process is to be performed in a subframe on the second cell or not, a control channel and/or a data channel with a start position in the subframe out of at least two start positions. The radio access node is additionally configured to transmit control information on the control channel and/or data on the data channel as scheduled to the communication terminal.

In addition, the object is achieved by providing a communication terminal for handling communication in a wireless communication network. The communication terminal is configured to communicate with a radio access node in a first cell on a carrier of a licensed or unlicensed spectrum and/or a second cell on a carrier of an unlicensed spectrum. The communication terminal is further configured to receive a configuration from the radio access node, which configuration defines that the communication terminal is to monitor at least two start positions for a control channel intended for the communication terminal. The communication terminal is also configured to monitor the at least two start positions for reception of the control channel.

Since the radio access node can use at least two different start positions the radio access node can vary the length of the transmission properly within a subframe if the radio access node partly stops transmission in the subframe because of e.g. performing LBT. This results in that resources of the subframe may be efficiently used leading to an improved performance of the wireless communication network.

### BRIEF DESCRIPTION OF THE DRAWINGS

Embodiments will now be described in more detail in relation to the enclosed drawings, in which:

FIG. 1 is a schematic overview depicting an LTE downlink physical resource.

FIG. 2 is a schematic overview depicting an LTE radio frame structure.

FIG. 3 is a schematic overview depicting a downlink subframe in LTE.

FIG. 4 is a schematic overview depicting a bandwidth of a carrier aggregation.

FIG. 5 is a schematic illustration illustrating a LBT process or method.

FIG. 6 is a schematic overview depicting a Licence-assisted Access (LAA) to an unlicensed frequency spectrum using LTE carrier aggregation.

FIG. 7a is a schematic overview depicting a wireless communication network according to embodiments herein.

FIG. 7b is a flowchart of a method performed in a radio access node according to embodiments herein.

FIG. 7c is a flowchart of a method performed in a communication terminal according to embodiments herein.

FIG. 8 is a combined flowchart and signalling scheme according to embodiments herein.

FIG. 9 is a combined flowchart and signalling scheme according to embodiments herein.

FIG. 10 is a flowchart of a method performed in a radio access node according to some embodiments herein.

FIG. 11 is a flowchart of a method performed in a communication terminal some according to embodiments herein.

FIG. 12 is a block diagram depicting a radio access node according to embodiments herein.

FIG. 13 is a block diagram depicting a communication terminal according to embodiments herein.

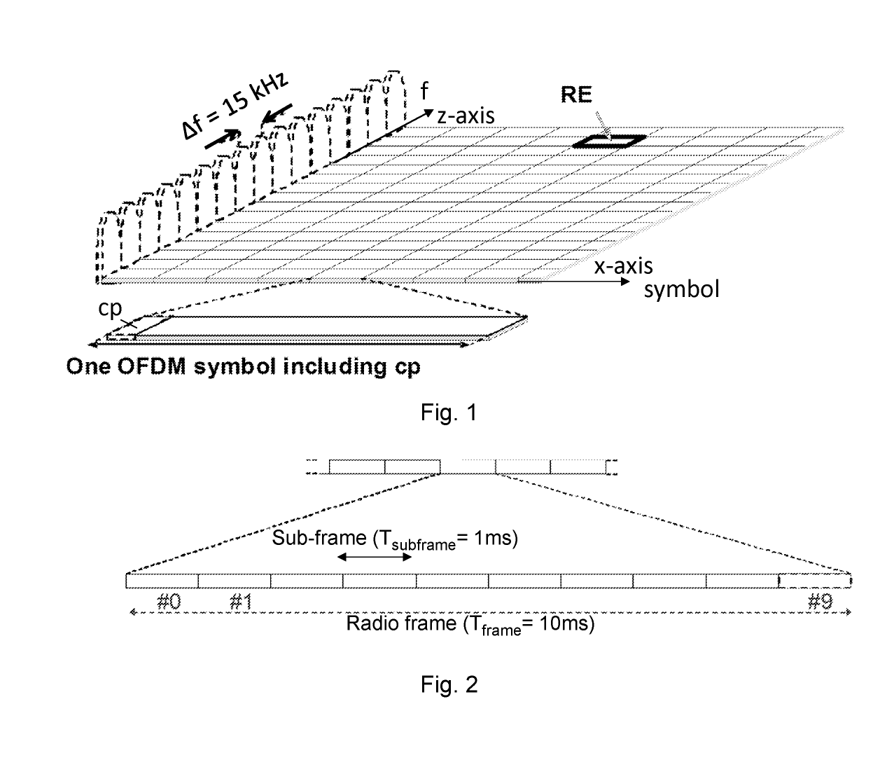

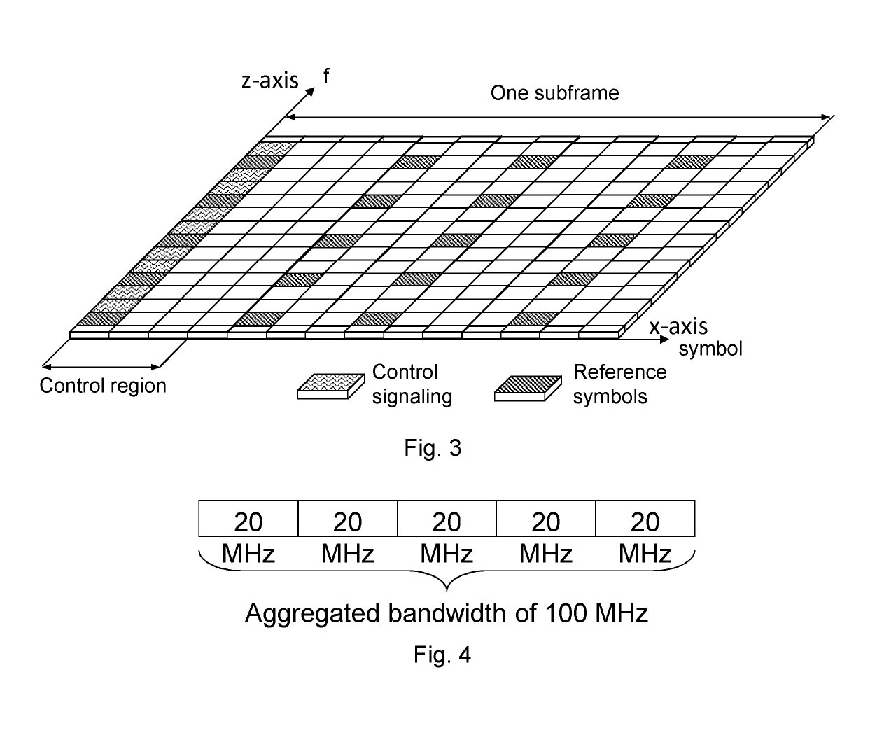

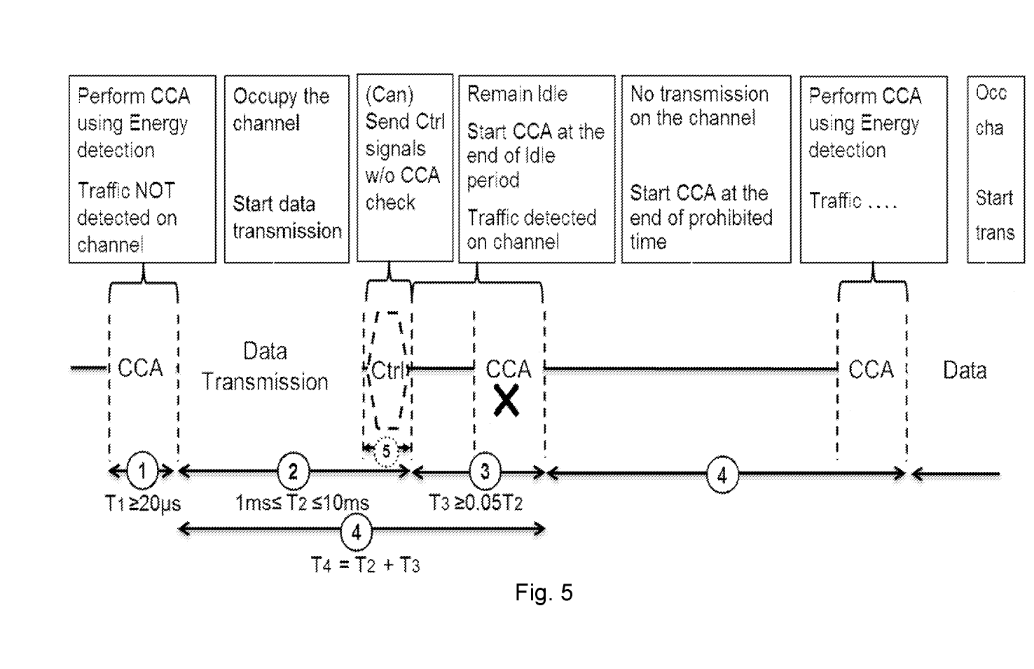

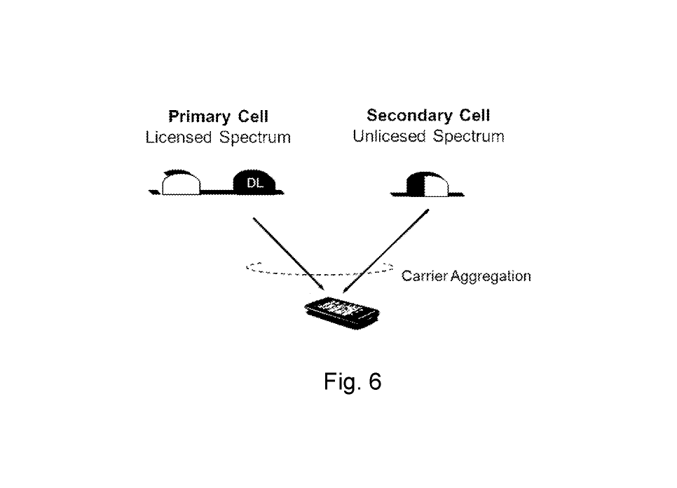

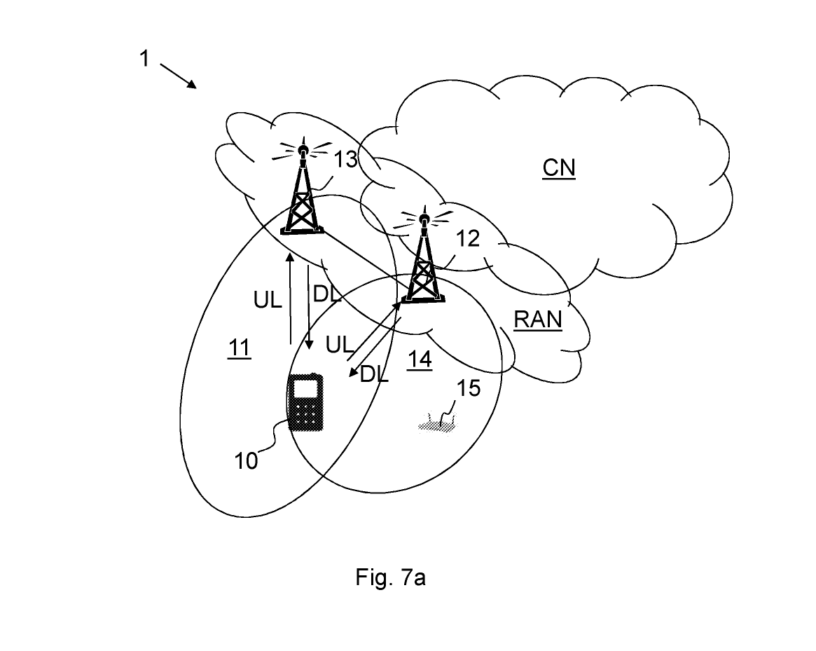

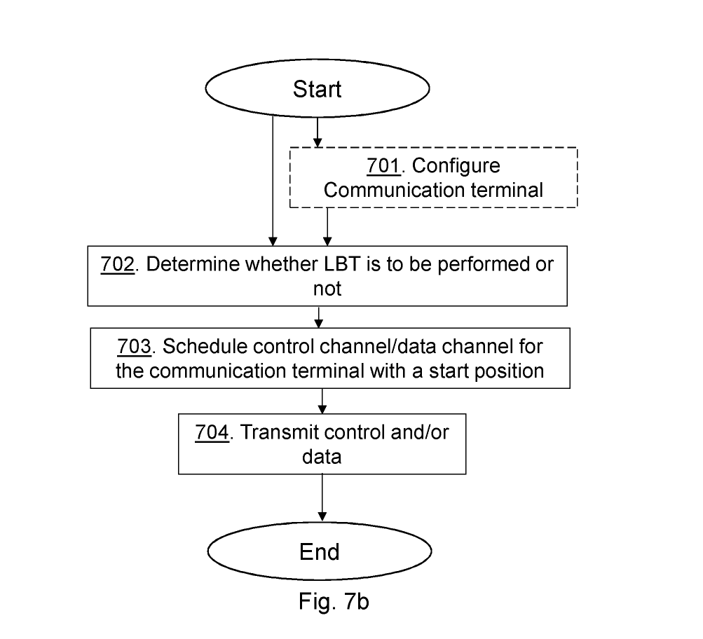

### DETAILED DESCRIPTION

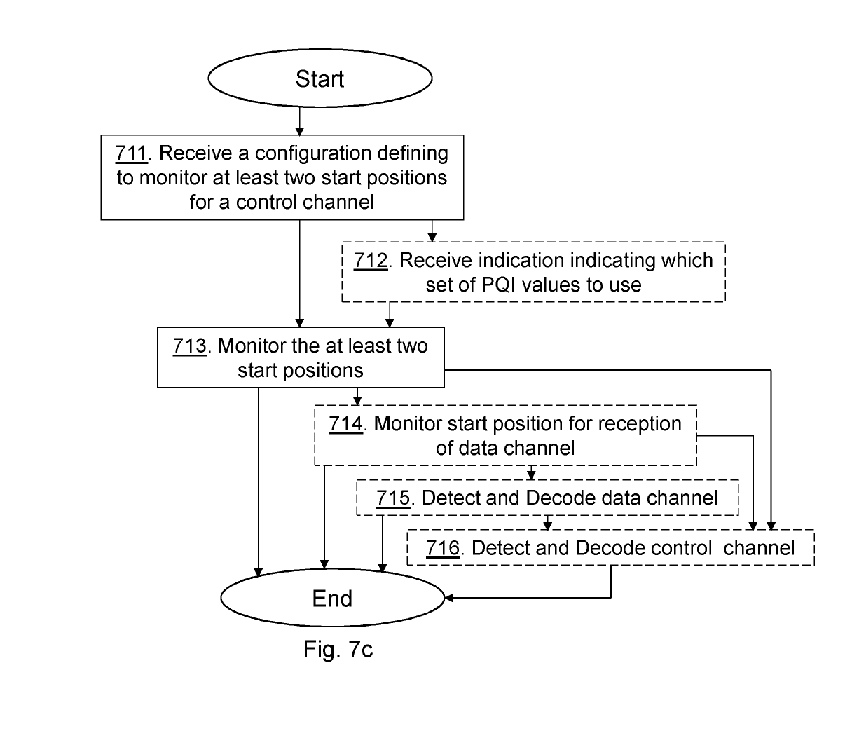

Embodiments herein relate to wireless communication networks in general. FIG. 7a is a schematic overview depicting a wireless communication network 1. The wireless communication network 1 comprises one or more RANs and one or more CNs. The wireless communication network 1 may use a number of different technologies, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. The wireless communication network 1 is exemplified herein as an LTE network.

In the wireless communication network 1, a communication terminal 10, also known as a wireless device, a user equipment and/or a wireless terminal, communicates via a Radio Access Network (RAN) to one or more core networks (CN). It should be understood by the skilled in the art that “communication terminal” is a non-limiting term which means any wireless terminal, user equipment, Machine Type Communication (MTC) device, a Device to Device (D2D) terminal, or node e.g. smartphone, laptop, mobile, sensor, relay, mobile tablets or even a small base station communicating within a cell.

Communication terminals connect in the licensed spectrum, to a first cell 11 e.g. a Primary Cell (PCell), and use carrier aggregation to benefit from additional transmission capacity in the unlicensed spectrum, whereby they connect to a second cell 14 e.g. a Secondary Cell (SCell) also referred to as Licensed Assisted (LA) SCell. To reduce the changes required for aggregating licensed and unlicensed spectrum, a frame timing in the first cell 11 is simultaneously used in the second cell 14. The first cell may be of a licensed or unlicensed spectrum and the second cell may be of an unlicensed spectrum.

The wireless communication network 1 covers a geographical area which is divided into cell areas, e.g. the first cell 11 and the second cell 14. The second cell 14 is served by a first radio access node 12 providing radio coverage over the second cell 14.

The first cell 11 is being served by a second radio access node 13. The radio access nodes may be radio base stations such as NodeBs, evolved Node Bs (eNB, eNode B), base transceiver stations, Access Point Base Stations, base station routers, remote radio units, or any other network units capable of communicating with a communication terminal within the cell served by the respective radio access node depending e.g. on the radio access technology and terminology used. The radio access nodes may serve one or more cells. A cell is a geographical area where radio coverage is provided by radio base station equipment at a base station site or at remote locations in Remote Radio Units (RRU). The cell definition may also incorporate frequency bands and radio access technology used for transmissions, which means that two different cells may cover the same geographical area but use different frequency bands.

The radio access nodes communicate over the air or radio interface operating on radio frequencies with the communication terminal 10 within range of the respective radio access node. The communication terminal 10 transmits data over the radio interface to the respective radio access node in Uplink (UL) transmissions and the respective radio access node transmits data over an air or radio interface to the communication terminal 10 in Downlink (DL) transmissions.

The first radio access node 12 serving the second cell 14 uses a carrier of an unlicensed frequency spectrum, which unlicensed frequency spectrum may also be used by an access point 15 such as a WFi modem, a hotspot or similar. Since the unlicensed frequency spectrum must be shared with other communication terminals or radio access nodes, potentially operating according to other radio standards such as IEEE 802.11n, of similar or dissimilar wireless technologies, a so called Listen-Before-Talk (LBT) method needs to be applied. Thus, the first radio access node 12 may use a LBT process before transmitting to the communication terminal 10. According to embodiments herein the first radio access node 12 or the second radio access node 13 determines a start symbol out of at least two start symbols for a control channel, e.g. PDCCH or EPDCCH, and/or a data channel, e.g. PDSCH, based on whether the first radio access node 12 performs LBT in a subframe, occupying one or more symbols, or not. This enables the communication terminal 10 to detect the control channel and/or the data channel even when the first radio access node 12 performs an LBT procedure.

This implies that the PDSCH and EPDCCH start symbols in the subframe, and thus their transmission time, within the subframe, varies depending on whether the network is performing LBT in this subframe or not.

In some embodiments herein control information to the communication terminal is transmitted on a carrier where LBT does not need to be used, but data transmissions to the communication terminal are scheduled on the carrier where LBT needs to be used. This is denoted as cross-carrier scheduling where e,g, the PCell uses a licensed carrier.

Embodiments herein provide a solution that beneficially handles variation in transmission time due to LBT by adjusting the control channels and/or data channels to be transmitted properly and providing the corresponding information to the communication terminal such that the communication terminal can behave accordingly. Embodiments herein relate to a method in a radio access node, such as the first or the second radio access node, for scheduling the control channel e.g. PDCCH and/or EPDCCH, or the data channel, e.g. a shared data channel such as PDSCH, to the communication terminal 10 in the wireless communication network 1. The radio access node serves the communication terminal 10 either in the first cell 11, e.g. a primary cell, or the second cell 14, e.g. a secondary cell. The radio access node may schedule the communication terminal 10 in a cross-carrier manner, i.e. the radio access node may schedule transmissions for the communication terminal also for a cell on one carrier from a cell on another carrier. The cell on the other carrier may be controlled by the radio access node. The cell for which transmissions are scheduled may be controlled by the same radio access node or by a different, i.e. another, radio access node. The radio access node may determine whether LBT is performed or not in the second cell. The radio access node then determines or schedules, based on whether a LBT process is performed in the subframe on the second cell, the start symbol or start position in the subframe out of at least two start symbols or positions for the control channel and/or the start position of the data channel such as the PDSCH. The radio access node may then transmit the control channel and/or the data channel as scheduled or determined to the communication terminal 10. The configuration of the start symbols of the control channel and/or the data channel may be configured at the communication terminal 10 from or by the radio access node.

The problem of mismatch between the radio access node and the communication terminal 10 in transmission time due to LBT may further be solved by using higher layer signaling and dynamic signaling where information about the starting OFDM symbol for the EPDCCH and/or the PDSCH within the subframe is provided to the communication terminal 10 for the subframes in which LBT is performed as well as for subframes without LBT. In order to increase flexibility to access the channel, i.e. provide more start positions, the number of bits to signal the EPDCCH and/or PDSCH starting OFDM symbol may be increased from 2 bits to 3 or 4 bits.

Some embodiments herein allow more alternatives for configurable EPDCCH sets or configurations such that an EPDCCH may be configured to start at more alternative OFDM symbols or start positions. Embodiments also allow e.g. more configurable PQI states, also referred to as set of PQI values, and to expand the bit width, e.g. number of bits, in a DCI message to allow indexing said more possible configurable PQI states. LBT on an unlicensed carrier can be done by configuring the starting OFDM symbol of EPDCCH and corresponding PDSCH to the second OFDM symbol or later for a first EPDCCH set by means of for example PQI configuration. Therefore the radio access node can listen to the channel before starting the EPDCCH transmission and the communication terminal will not expect signals corresponding to the EPDCCH and/or the PDSCH during the period where the radio access node or the different radio access node performs LBT in a subframe.

In subframes without LBT operation, i.e. where LBT is not performed, a second EPDDCH set can be used where the starting OFDM symbol can be configured to be the first OFDM symbol, i.e. the whole subframe can be utilized. Hence, by embodiments herein, there can be a dynamic switch on a per subframe basis, by the radio access node, between performing LBT and not performing LBT and when LBT is not used, the whole subframe can be utilized for PDSCH transmission.

In order to increase the flexibility to access the channel after LBT, the starting OFDM symbol for Evolved PDSCH and/or PDSCH in PQI configuration for example can be extended to be signaled by 3 or 4 bits.

Hence, as the radio access node can use at least two different start positions the radio access node can vary the length of the transmission properly within a subframe if the radio access node partly stops transmission in the subframe because of e.g. performing LBT. Since the communication terminal can monitor at least the two start positions the communication terminal 10 may adjust the time interval that it can expect signals such as control or data channels accordingly which increases the reliability of successful reception.

FIG. 7b is a schematic flowchart depicting a method performed in a radio access node such as the first radio access node 12 and/or the second radio access node 13 for scheduling a control channel and/or a data channel to the communication terminal 10 in the wireless communication network 1 according to embodiments herein. The radio access node serves the communication terminal 10 in at least one of the first cell on a carrier of a licensed or unlicensed spectrum, or the second cell on a carrier of an unlicensed spectrum.

Action 701. The radio access node may configure the communication terminal 10 with a configuration, which configuration defines that the communication terminal 10 is to monitor at least two start positions for the control channel intended for the communication terminal 10. Hence, the radio access node configures the communication terminal with the at least two start positions for the control channel and/or the data channel. The radio access node may configure the communication terminal 10 with at least two different sets of PQI values.

Action 702. The radio access node determines whether a LBT process is to be performed or not in the second cell 14.

Action 703. The radio access node schedules, based on whether the LBT process is to be performed in a subframe on the second cell or not, the control channel and/or the data channel with a start position in the subframe out of the at least two start positions. The two start positions being of a same control/data channel or a different control/data channel. The radio access node may schedule the control channel and/or data channel intended for the communication terminal 10 by scheduling transmission of data on the data channel on the second cell in a cross carrier manner from the first cell. The radio access node may schedule the start position in the subframe out of at least two start positions by scheduling the data channel at an earlier start position than the control channel. The data channel may be scheduled in a next subframe, when LBT has been performed in a previous subframe. The control information may be received after LBT or the data channel may be transmitted in the same subframe as the control channel, earlier but still after LBT. The data channel may be transmitted from the beginning of the subframe and the control channel, located to allow for LBT, may be transmitted later in the subframe.

The control channel may be one out of at least two control channels, and wherein the at least two start positions correspond to the at least two control channels such that one of the at least two control channels corresponds to a start position later in the subframe to be scheduled when the LBT process to be performed and another one of the at least two control channels corresponds to a start position earlier in the subframe to be scheduled when no LBT process is to be performed. The control channel may be of an

EPDCCH set that contains a common search space and that uses a start position that allows for LBT. Each control channel out of the at least two control channels may be associated with one of a configured PQI state which each include a parameter, pdsch-Start-r11, giving the start position of the control channel.

Action 704. The radio access node transmits control information on the control channel and/or data on the data channel as scheduled to the communication terminal 10. In some embodiments the radio access node transmits the control information comprising an indication indicating the start position for the data channel based on one of the at least two sets of PQI values. E.g. DCI format 2D or similar future DCI formats indicates to the communication terminal 10 which of the PQI, and hence which starting OFDM symbol, is applicable to a scheduled PDSCH.

FIG. 7c is a schematic flowchart depicting a method performed by the communication terminal 10 for handling communication in the wireless communication network 1 according to embodiments herein. The communication terminal 10 is configured to communicate with the radio access node in the first cell 11 of a licensed or unlicensed spectrum and/or the second cell 14 an unlicensed spectrum.

Action 711. The communication terminal 10 receives a configuration from the radio access node, which configuration defines that the communication terminal 10 is to monitor at least two start positions for a control channel intended for the communication terminal 10. The communication terminal 10 may e.g. receive a configuration with at least two different sets of PQI values.

Action 712. The communication terminal 10 may receive from the radio access node, the indication indicating which set of PQI values to use for determining a start position of the data channel. E.g. control information may comprise an indication indicating the start position for the data channel based on one of the at least two sets of PQI values.

Action 713. The communication terminal 10 monitors the at least two start positions for reception of the control channel.

Action 714. The communication terminal 10 may monitor the start position for reception of a data channel in a subframe.

Action 715. The communication terminal 10 may detect and decode the data channel.

Action 716. The communication terminal 10 may detect and decode the control channel.

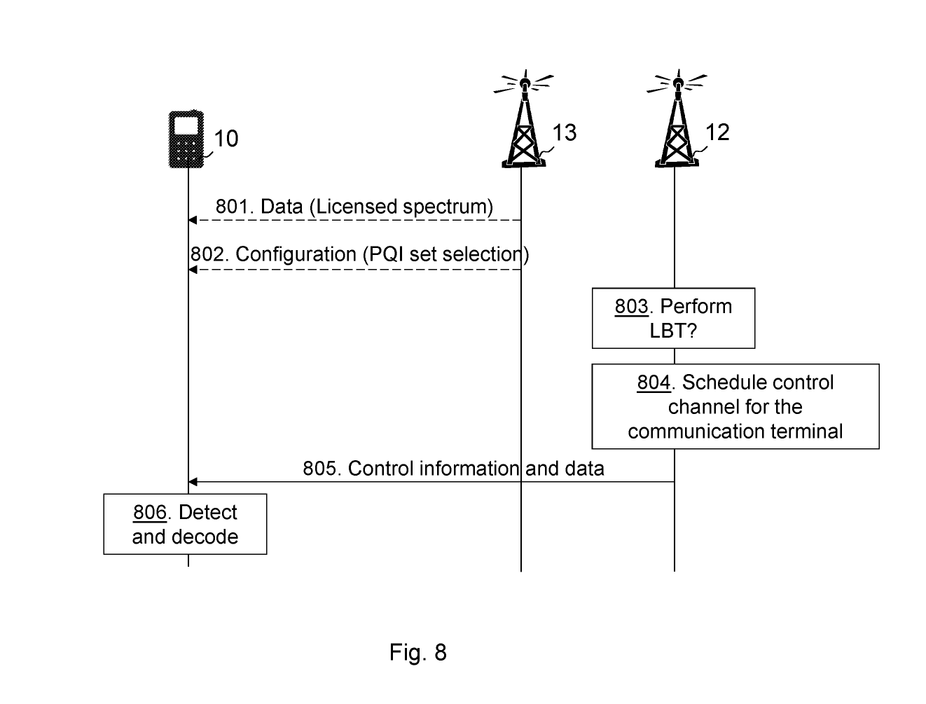

FIG. 8 is a combined flowchart and signaling scheme according to some embodiments herein wherein the first radio access node 12 schedules control and/or data channel for the communication terminal 10 in the second cell 14 of the unlicensed spectrum.

Action 801. The second radio access node 13 serving the first cell 11 such as a PCell transmits data and/or scheduling information e.g. DCI to the communication terminal 10 regarding the first cell 11.

Action 802. The second radio access node 13 may, via RRC signaling, configure the communication terminal 10. The RRC signaling may comprise information about starting OFDM symbols for EPDCCH and/or PDCCH within a subframe for the subframes in which LBT is performed as well as for subframes without LBT. Furthermore, the RRC signaling may comprise index of configurable PQI states providing more configurable PQI states in order to provide more alternatives for start symbols for the PDSCH. E.g. a first index may indicate start positions 0,1,2,4 while a second index may indicate start positions 1,2,4,6. This may alternatively be done from the first radio access node 12.

Action 803. The first radio access node 12 determines whether to perform LBT or not e.g. the first radio access node 12 may check whether to perform LBT in a subframe or not for occupying a wireless channel for communication. For example, if the first radio access node 12 already transmits on the carrier of unlicensed spectrum there is no need to perform LBT, but if first radio access node 12 wants to start transmission the LBT process may need to be performed.

Action 804. The first radio access node 12 then schedules the control channel out of at least two control channels for the communication terminal 10 based on whether the first radio access node 12 performs LBT or not. The control channels may be two EPDCCH sets or an EPDCCH and a PDCCH. The first radio access node 12 may select the control channel with a start symbol in a position in the subframe that is e.g. after a LBT process is performed prior to transmission. The LBT process may or may not be contained within the subframe. The first radio access node 12 has at least two alternative start symbols to select among as the start symbol for the control channel either as two different start positions of a certain control channel or different control channels with different start positions. Furthermore, the first radio access node 12 may alternatively or additionally schedule or select a start position in the subframe for the data channel e.g. PDSCH out of at least two start positions for the communication terminal 10 based on whether the first radio access node 12 performs LBT or not.

Action 805. The first radio access node 12 then transmits control information such as DCI to the communication terminal 10 over the control channel with the selected start symbol i.e. the control channel starts at the selected/determined/scheduled start symbol. The DCI information may comprise PQI indicating a start of the PDSCH. The first radio access node 12 further transmits data over the PDSCH according to the DCI information for the PDSCH.

Action 806. The communication terminal 10 may then detect the control channel and decode the control information as configured and also uses the PQI to find where data over the PDSCH starts.

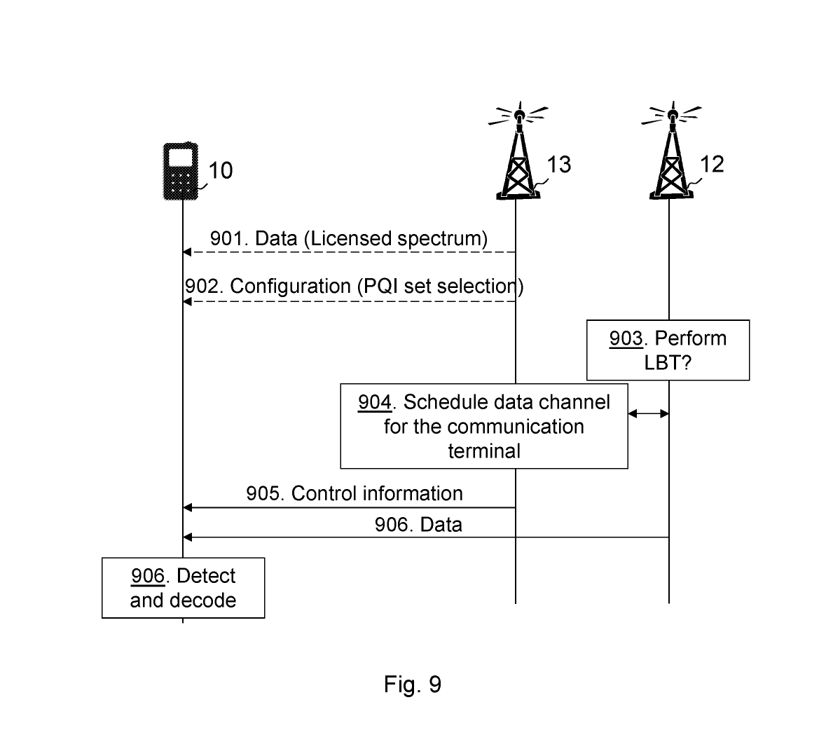

FIG. 9 is a combined flowchart and signaling scheme according to embodiments herein wherein cross-carrier scheduling is performed from the second radio access node 13 for the second cell 14 controlled by the first radio access node 12.

Action 901. The second radio access node 13 serving the first cell 11 such as a PCell transmits data and/or scheduling information e.g. DCI to the communication terminal 10 concerning scheduling of data transmissions on the first cell 11.

Action 902. The second radio access node 13 may, via RRC signaling, configure the communication terminal 10 for the second cell 14. The RRC signaling may comprise information about starting OFDM symbol for PDSCH within a subframe for the subframes in which LBT is performed as well as for subframes without LBT. Furthermore, the RRC signaling may comprise index of configurable PQI states providing more configurable PQI states in order to provide more alternatives for start symbols for the PDSCH.

Action 903. The first radio access node 12 determines whether to perform LBT or not. For example, if the radio access node already transmits on the carrier of unlicensed spectrum, i.e. on the second cell14, there is no need to perform LBT, but if first radio access node 12 wants to start transmission the LBT process may need to be performed. This is informed/signaled to the second radio access node 13.

Action 904. The second radio access node 13 may then schedule data on PDSCH to start at a selected start position or may determine a start position/symbol for the data channel, e.g. the PDSCH, out of at least two start positions/symbols for the communication terminal 10 based on whether the first radio access node 12 performs LBT or not. The second radio access node 13 may select a start symbol in a position that is e.g. after a LBT process is performed in the sub-frame. The second radio access node 13 has at least two alternative start symbols to select among as the start symbol for the data channel. Whether the LBT is performed or not may be obtained from the first radio access node 12 as indicated by the double directed arrow as stated in action 903.

Action 905. The second radio access node 13 then transmits control information such as DCI to the communication terminal 10 over the control channel, e.g. the PDCCH or EPDCCH. The control information comprises PQI index indicating the start position/symbol of the data channel as selected in Action 904.

Action 906. The first radio access node 12 further transmits data on the data channel, PDSCH, to the communication terminal 10 as scheduled in the control information transmitted in Action 905.

Action 907. The communication terminal 10 then detects the control channel and decodes the control information and also uses the PQI to find where data over the PDSCH starts in the second cell 14.

Here follows an introduction of how e.g. the PDSCH and EPDCCH start symbols 30 are obtained in current standards and how this may be utilized or modified, by embodiments herein.

For PDSCH transmission based on Transmission Mode (TM) 1-9

1. For the case (denoted Case 1) where the scheduling DCI is transmitted on the same cell as the PDSCH, e.g. control information and data are transmitted over the second cell 14 to the communication terminal 10 from the first radio access node 12:
If the serving cell is a PCell, the communication terminal 10 may be configured in Action 802 to monitor the UE-specific search space on at least two EPDCCH sets and it will by default also monitor, in Action 806, the common search space on the PDCCH region. The at least two EPDCCH sets are either higher layer configured with the same EPDCCH starting OFDM symbol position that is greater than 0 or their starting symbols follows the CFI. Together with the PDCCH region, at least two possible DCI transmission starting positions are available, depending on whether the DCI is transmitted from PDCCH, which gives the start symbol 0, or EPDCCH, which gives the start symbol 1,2,3 or 4. The first radio access node 12 shall perform LBT and determine to transmit each DCI message on either PDCCH or EPDCCH on one of the configured sets. In case of EPDCCH scheduling, the corresponding starting OFDM symbol position of the scheduled PDSCH is the same as the starting OFDM symbol of the EPDCCH received by the communication terminal 10. In case of PDCCH scheduling, the starting OFDM symbol position of the scheduled PDSCH is determined by the PCFICH transmitted in the 1^{st} OFDM symbol. Hence, in one implementation of embodiments herein, when LBT is used, then PDSCH may be scheduled from EPDCCH with a higher layer configured start symbol. This will ensure that the first 1, 2, 3 or 4 OFDM symbols are unused. If LBT is not used, then PDSCH can be scheduled from PDCCH.
If the serving cell is a SCell, there is no PDCCH monitored by the communication terminal 10 when EPDCCH is configured. In this case, the communication terminal 10 may be configured to monitor the UE-specific search space on at least two EPDCCH sets. The at least two EPDCCH sets are higher layer configured with an EPDCCH starting OFDM symbol position, which is the same for both sets, different from symbol 0, which allows the first radio access node 12 to perform LBT and determine to transmit the EPDCCH either of the configured sets allowing LBT. The corresponding starting OFDM symbol position of the scheduled PDSCH is the same as the starting OFDM symbol of the EPDCCH received by the UE or communication terminal 10.

2. For the case (denoted Case 2) where the scheduling DCI is transmitted on a cell different than that for the PDSCH, that is, where the DCI is transmitted from the second radio access node 13 e.g. in a cross carrier scheduling process:
PDSCH starting OFDM symbol on the SCell is RRC configured and should be set to a value allowing LBT, i.e., the starting OFDM symbol index should be greater than 0. For the serving cell, i.e. the second cell 14, to carry the PDSCH, the first radio access node 12 shall perform LBT on the SCell to determine whether CRS, or any other signals, should be transmitted, possibly prior to the PDSCH transmission, and whether the PDSCH can be transmitted at the configured starting OFDM symbol.
In case the cell, e.g. the first cell 11, for transmitting DCI does not require LBT, the DCI can be transmitted from the second radio access node 13 via PDCCH or EPDCCH without higher layer configuration of the start symbol for PDSCH on the serving cell, e.g. the second cell 14, in which case the start symbol is derived from PCFICH.
In case the cell transmitting DCI requires LBT, in case the first cell 11 is unlicensed frequency spectrum as well, the DCI should be transmitted via EPDCCH configuration taught in Case 1 above.
   For PDSCH transmission based on TM10

3. For the case (denoted Case 3) where the communication terminal 10 is not configured to monitor DCI format 2D or similar future DCI formats:
The same teaching as in Case 1 and Case 2 shall be followed in this case.

4. For the case (denoted Case 4) where the communication terminal 10 is configured to monitor DCI format 2D or similar future DCI formats:
The communication terminal 10 shall be configured, in action 802, with at least two PQI states with at least two different PDSCH start OFDM symbol positions, currently given by an RRC signaling parameter pdsch-Start-r11 (TS 36.331). The current LTE specs allows up to four different PQI state configurations. The DCI format 2D or similar future DCI formats indicates to the communication terminal 10 which of the PQI, and hence which starting OFDM symbol, is applicable to the scheduled PDSCH. Hence, it is possible to dynamically control the PDSCH start symbol dependent on if LBT is used or not.
   The reserved state in pdsch-Start-r11 can be defined as OFDM start symbol 0. By this standard change, it is possible to start PDSCH already from symbol 0 if LBT is not used.
In case the cell for transmitting DCI does not require LBT, the DCI can be transmitted via PDCCH or EPDCCH without special configuration, i.e the CFI value in PCFICH will be followed.
In case the scheduling DCI is transmitted on a cell, e.g the first cell 11, different than that for the PDSCH, for the serving cell, e.g. the second cell 14, to carry the PDSCH, the first radio access node 12 shall perform LBT on the SCell such as the second cell 14 to determine whether CRS, or any other signals, should be transmitted, possibly prior to the PDSCH transmission, and whether the PDSCH may be transmitted at the configured starting OFDM symbol.
In case the cell upon which DCI is transmitted requires LBT, e.g. the second cell 14, the DCI may be transmitted via EPDCCH with a start symbol different from 0. In TM10, each EPDCCH set is associated with one of the configured PQI state which each include a parameter pdsch-Start-r11. The EPDCCH start symbol is given by this parameter, for the associated EPDCCH set. Hence, the two sets may have different EPDCCH start symbols. Particularly, if the reserved state is modified to imply start symbol 0, then one EPDCCH set could start at 0. i.e. no LBT. and the other at a start symbol >0, i.e. allowing LBT to be performed. This gives the flexibility to dynamically switch between LBT and no LBT on a per subframe basis. This is beneficial since it maximizes the utilization of resources and throughput.

In any of the above cases, additional indication signals may be transmitted with PDSCH to assist the communication terminal 10 in determining the starting symbol of said PDSCH.

In any of the above cases, if the communication terminal 10 fails to detect any

PDSCH, it may provide a DTX HARQ-ACK feedback either implicitly, by not transmitting a HARQ-ACK feedback, or explicitly, by transmitting a signal corresponding to DTX state.

In the first approach, as shown in FIG. 8, we assume that the communication terminal 10 is scheduled on the unlicensed carrier that is also the same carrier for the PDSCH. In the first example the communication terminal 10 is configured with two EPDCCH sets. It is noted here that this may be implemented as a solution for the first radio access node 12 to provide LBT functionality. In each set, the PDSCH that is scheduled by EPDCCH would then have a starting OFDM symbol that is indicated by the PQI state indicator. In an example, the first EPDCCH set is configured to have a starting OFDM symbol that corresponds to operation without LBT. This could be done for example by configuring this EPDCCH set to start at the first OFDM symbol, i.e OFDM symbol is ‘0’ in case the reserved value in pdsch-Start-r11 is defined as ‘0’, or the second OFDM symbol.

For the second EPDCCH set the starting OFDM symbol may in some embodiments allow for LBT at the beginning of the subframe by having a starting OFDM symbol that is at the second, third or fourth OFDM symbol. For the scheduled PDSCH, the starting OFDM would be similarly adjusted so that LBT can be performed at the beginning of the subframe. The above changes may further require as well that CRS is not transmitted in the first OFDM symbol. Hence, when performing LBT, the CRS is not transmitted in the first OFDM symbol. This may be part of implementation in the first radio access node 12.

It is further noted here that embodiments herein may be extended by allowing more than two EPDCCH sets. In such a case the PDSCH that is scheduled by EPDCCH would then have a starting OFDM symbol that is indicated by the PQI state indicator. At least one of the EPDCCH set is configured to have a starting OFDM symbol that corresponds to operation without LBT, e.g. mapping the EPDCCH to either the first or second OFDM symbol. The other EPDCCH sets would then have different starting OFDM symbols configured corresponding to when the channel can be accessed after LBT is performed. For example one EPDCCH set may have starting OFDM symbol four and another EPDCCH set may have starting OFDM symbol six. If a common search space is introduced in EPDCCH, the start symbol must be pre-defined since RRC signaling is not possible before attaching to the cell. Hence an EPDCCH set that contains the common search space uses, e.g. always uses, an OFDM start symbol that allows for LBT. Which start symbol to use can be described in standard specifications, or signaled as system information in a broadcast channel. The benefits of this is that the LBT can be performed at a later point in the subframe, which increases the possibility that the network discovers an unoccupied channel, compared to when LBT is only performed in the beginning of the subframe. This improves the possibilities for the network to grab the channel.

In a second approach we assume that the communication terminal 10 is scheduled from another carrier than the carrier that the PDSCH is located on i.e. the use of cross-carrier scheduling. The scheduling channel of e.g. either PDCCH or EPDCCH is located on another carrier either on a licensed or an unlicensed frequency.

In embodiments herein the starting OFDM symbol for EPDCCH and corresponding PDSCH, or only PDSCH in case of cross-carrier scheduling, in e.g. the PQI configuration can be extended from the current set that is {1,2,3,4} by either using only the 2 bits and redefine or modify the interpretation of the bit combinations, for example to the set {1,2,4,6}, or extending the number of PQI bits in the DCI message.

In an example, the starting OFDM symbol for EPDCCH and/or PDSCH in the PQI set can be signaled using 3 bits. In this manner, the possibility of LBT in the first slot is extended beyond the 4^{th} OFDM symbol. In another example, the starting OFDM symbol for EPDCCH/PDSCH in the PQI set can be signaled using 4 bits giving an upper limit of 16 potentially different OFDM starting symbols. In this manner the possibility of LBT is extended even to the any symbol in the first or second slot since a slot extends or comprises seven OFDM symbols.

If the communication terminal 10 is configured with EPDCCH the following applies: Similarly to the first approach mentioned above, the communication terminal 10 is configured with at least two EPDCCH sets. In an example the first EPDCCH set in PQI is configured such that it can be used for transmission without LBT by configuring the starting OFDM symbol for PDSCH on the carrier with scheduled data at the first or second OFDM symbol. For the second EPDCCH set the starting OFDM symbol for PDSCH on the carrier with scheduled data should allow for LBT at the beginning of the subframe. This can be done by configuring a starting OFDM symbol for PDSCH in the PQI to be at least the second, third or fourth OFDM symbol. The idea can be further extended by allowing more than two EPDCCH sets that the communication terminal 10 searches for candidates within. At least one of the EPDCCH set is configured to have a starting OFDM symbol that corresponds to operation without LBT, e.g. mapping the EPDCCH to either the first or second OFDM symbol. The other EPDCCH sets would then have different starting OFDM symbols corresponding to when the channel can be accessed after LBT is performed. For example one EPDCCH set can for example have starting OFDM symbol four and another EPDCCH set can have starting OFDM symbol six.

If the communication terminal 10 is instead scheduled with PDCCH or alternatively with EPDCCH, in principle with only a single set, there are different possible options that can be considered for how the scheduling is performed. In one approach, the second radio access node 13 schedules the communication terminal 10 with PDCCH in a cross-carrier manner only after the first radio access node 12 has performed LBT operation on the SCell. Here, the same techniques as disclosed before are used with the EPDCCH start symbol on the PCell and the PDSCH on the SCell occurring after the first symbol.

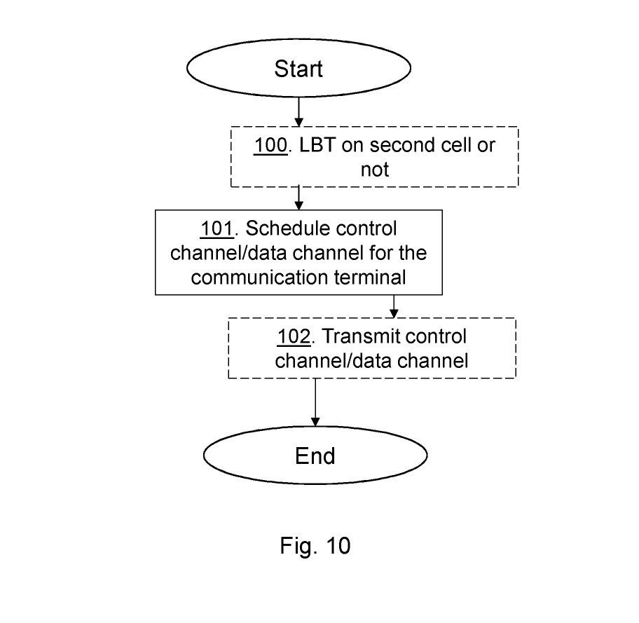

FIG. 10 is a flowchart depicting a method, according to some embodiments, performed in a radio access node, such as the first radio access node 12 or the second radio access node 13, for scheduling a control and/or data channel to the communication terminal 10 in the wireless communication network 1. The radio access node serves the communication terminal either in a first cell 11, e.g. a primary cell, or a second cell 14, e.g. a secondary cell. The radio access node may schedule the communication terminal 10 in a cross carrier manner, e.g. the radio access node may schedule transmissions for the communication terminal also for a cell controlled by a different radio access node or the same radio access node. Thus, the radio access node, e.g. the second radio access node 13, may communicate with the different radio access node, e.g. the first radio access node 12, or vice versa. Actions that are performed in some embodiments but not in other embodiments are marked as dashed boxes.

Action 100. The radio access node may determine whether LBT is to be performed or not. For example, the radio access node may determine to perform LBT when trying to access a frequency carrier or the radio access node may obtain information from the second cell 14, or from the first radio access node 12, that LBT is or needs to be performed in the second cell 14.

Action 101. The radio access node determines or schedules, based on whether a LBT process is performed in a subframe on the second cell 14, a start symbol or start position out of at least two start symbols or positions for the control channel and/or the data channel.

Action 102. The radio access node may then transmit the control channel and/or data channel as scheduled or determined to the communication terminal 10.

In some embodiments the radio access node may transmit to the communication terminal, e.g. via RRC signaling, an indication indicating a set of PQI values out of at least two sets of PQI values for the communication terminal 10 to use in e.g. the second cell 14. A PQI value indicates a start symbol for the data channel.

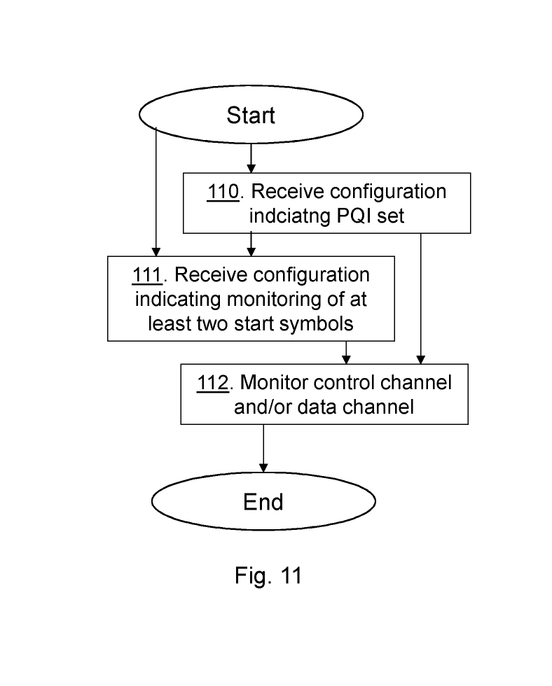

FIG. 11 is a flowchart depicting a method, according to some embodiments herein, performed in the communication terminal 10 for handling communication in the wireless communication network 1. The communication terminal is served by a radio access node either in the first cell 11 e.g. a primary cell, and the second cell 14, e.g. a secondary cell. The radio access node may schedule the communication terminal in a cross carrier manner, e.g. the radio access node may schedule transmissions for the communication terminal also for a cell controlled by a different radio access node.

Action 110. The communication terminal 10 receives configuration from the radio access node, such as the second radio access node 13, for e.g. configuring one or more sets or states of PQI values to use. E.g. the communication terminal 10 may be configured with at least two different sets of PQI values and the radio access node may indicate which one to use.

Action 111. The communication terminal 10 receives configuration defining that the communication terminal 10 is to monitor at least two start symbols or positions for control channel intended to the communication terminal 10.

Action 112. The communication terminal 10 may then monitor, as configured, the at least two start symbols of the control channel, PDCCH or EPDCCH, e.g. during a communication. The communication terminal 10 may then also or alternatively monitor data over PDSCH starting in the subframe as indicated by the PQI value.

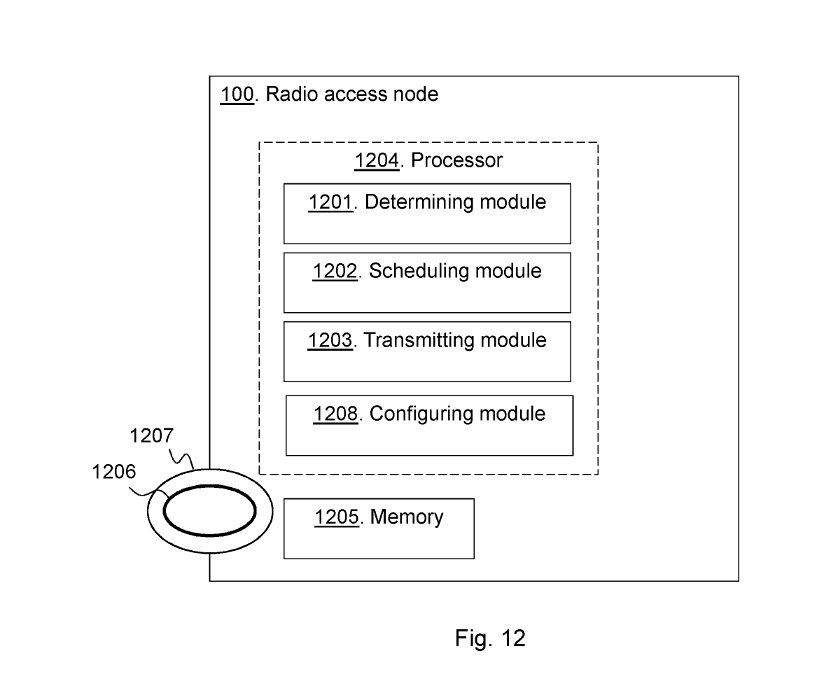

In order to perform the methods herein a radio access node 100, such as the first radio access node 12 and the second radio access node 13, is provided. FIG. 12 is a block diagram depicting the radio access node 100 such as the first radio access node 12 and/or the second radio access node 13 for scheduling a control and/or data channel to the communication terminal 10 in the wireless communication network 1 according to embodiments herein. The radio access node 100 is configured to serve the communication terminal 10 in at least one of the first cell on a carrier of a licensed or unlicensed spectrum, or the second cell on a carrier of an unlicensed spectrum.

The radio access node 10 may be configured to configure the communication terminal 10 with a configuration, which configuration defines that the communication terminal 10 is to monitor at least two start positions for the control channel intended for the communication terminal 10. Hence, the radio access node 10 may be configured to configure the communication terminal 10 with the at least two start positions for the control channel and/or the data channel. The radio access node 10 may be configured to configure the communication terminal 10 with at least two different sets of PQI values. E.g. the radio access node may transmit a setup configuration for configuring the communication terminal with the at least two different sets of PQI values.

The radio access node 100 is configured to determine whether a LBT process is to be performed or not in the second cell 14.

The radio access node 100 is configured to schedule, based on whether the LBT process is to be performed in a subframe on the second cell or not, the control channel and/or the data channel with a start position in the subframe out of the at least two start positions. The two start positions being of a same control/data channel or a different control/data channel. The radio access node may be configured to schedule the control channel and/or data channel intended for the communication terminal 10 by being configured to schedule transmission of data on the data channel on the second cell in a cross carrier manner from the first cell. The radio access node may be configured to schedule the start position in the subframe out of at least two start positions by scheduling the data channel at an earlier start position than the control channel.

The control channel may be one out of at least two control channels, and wherein the at least two start positions correspond to the at least two control channels such that one of the at least two control channels corresponds to a start position later in the subframe to be scheduled when the LBT process to be performed and another one of the at least two control channels corresponds to a start position earlier in the subframe to be scheduled when no LBT process is to be performed. The control channel may be of an EPDCCH set that contains a common search space, and use a start position that allows for LBT. Each control channel out of the at least two control channels may be associated with one of a configured PQI state which each include a parameter, pdsch-Start-r11, giving the start position of the control channel.

The radio access node 100 is configured to transmit control information on the control channel and/or data on the data channel as scheduled to the communication terminal 10. In some embodiments the radio access node 100 is configured to transmit the control information comprising an indication indicating the start position for the data channel based on one of the at least two sets of PQI values. E.g. DCI format 2D or similar future DCI formats indicates to the communication terminal 10 which of the PQI, and hence which starting OFDM symbol, is applicable to a scheduled PDSCH.

Thus, the radio access node is configured to serve the communication terminal 10 in the first cell 11 e.g. a primary cell and/or the second cell 14, e.g. a secondary cell. The radio access node may be configured to schedule the communication terminal 10 in a cross carrier manner, e.g. the radio access node may be configured to schedule transmissions for the communication terminal 10 also for a cell controlled by a different radio access node. Thus, the radio access node, e.g. the second radio access node 13, may be configured to communicate with the different radio access node, e.g. the first radio access node 12, or vice versa. The radio access node may alternatively be configured to serve both the first cell 11 and second cell 14.

The radio access node 100 may be configured to, by comprising a determining module 1201, determine whether LBT is to be performed or not. For example, the radio access node 100 and/or the determining module 1201 may be configured to determine to perform LBT when trying to access a frequency carrier of the second cell 14 or the radio access node 100 and/or the determining module 1201 may be configured to obtain information from the second cell 14, e.g. from the first radio access node 12, that LBT is performed or is to be performed in the second cell 14.

The radio access node 100 may be configured to, by comprising a scheduling module 1202, determine or schedule, based on whether a LBT process is performed or is to be performed in a subframe in the second cell 14, a start symbol or start position out of at least two start symbols or positions for the control channel and/or the data channel.

The radio access node 100 may be configured to, by comprising a transmitting module 1203, transmit the control channel and/or data channel as scheduled or determined to the communication terminal 10.

In some embodiments the radio access node 100 and/or the transmitting module 1203 may be configured to transmit to the communication terminal 10, e.g. via RRC signaling, an indication indicating start positions of the control channel and/or data channel within a subframe, e.g. indicating a set of PQI values out of at least two sets of PQI values for the communication terminal 10 to use in e.g. the second cell 14. A PQI value may indicate a start symbol for the data channel.

The embodiments herein for scheduling the control channel and/or the data channel may be implemented through one or more processors 1204 in the radio access node 100 depicted in FIG. 12, e.g. together with computer program code, which processors 1204 or processing means is configured to perform the functions and/or method actions of the embodiments herein.

The determining module 1201 and/or the one or more processors 1204 may be configured to determine whether a LBT process is to be performed or not in the second cell 14.

The scheduling module 1202 and/or the one or more processors 1204 may be configured to schedule, based on whether the LBT process is to be performed in a subframe on the second cell or not, the control channel and/or the data channel with a start position in the subframe out of the at least two start positions. The two start positions being of a same control/data channel or a different control/data channel. The scheduling and/or the one or more processors 1204 may be configured to schedule the control channel and/or data channel intended for the communication terminal 10 by being configured to schedule transmission of data on the data channel on the second cell in a cross carrier manner from the first cell. The scheduling and/or the one or more processors 1204 may be configured to schedule the start position in the subframe out of at least two start positions by scheduling the data channel at an earlier start position than the control channel.

The transmitting module 1203 and or the one or more processors 1204 may be configured to transmit control information on the control channel and/or data on the data channel as scheduled to the communication terminal 10. In some embodiments the transmitting module 1203 and or the one or more processors 1204 may be configured to transmit the control information comprising an indication indicating the start position for the data channel based on one of the at least two sets of PQI values. E.g. DCI format 2D or similar future DCI formats indicates to the communication terminal 10 which of the PQI, and hence which starting OFDM symbol, is applicable to a scheduled PDSCH.

The radio access node 100 may comprise a configuring module 1208. The configuring module 1208 and/or the one or more processors 1204 may be configured to configure the communication terminal 10 with the configuration, which configuration defines that the communication terminal 10 is to monitor at least two start positions for the control channel intended for the communication terminal 10. Hence, the configuring module 1208 and/or the one or more processors 1204 may be configured to configure the communication terminal 10 with the at least two start positions for the control channel and/or the data channel. The configuring module 1208 and/or the one or more processors 1204 may be configured to configure the communication terminal 10 with at least two different sets of PQI values.

The radio access node 100 further comprises a memory 1205. The memory 1205 comprises one or more units to be used to store data on, such as DCI information, LBT information, applications to perform the methods disclosed herein when being executed, and similar.

The methods according to the embodiments described herein for the radio access node 100 may be implemented by means of e.g. a computer program 1206 or a computer program product, comprising instructions, i.e., software code portions, which, when executed on at least one processor, cause the at least one processor to carry out the actions described herein, as performed by the radio access node 100. The computer program 1206 may be stored on a computer-readable storage medium 1207, e.g. a disc or similar. The computer-readable storage medium 1207, having stored there on the computer program 1206, may comprise the instructions which, when executed on at least one processor, cause the at least one processor to carry out the actions described herein, as performed by the radio access node 100. In some embodiments, the computer-readable storage medium 1207 may be a non-transitory computer-readable storage medium.

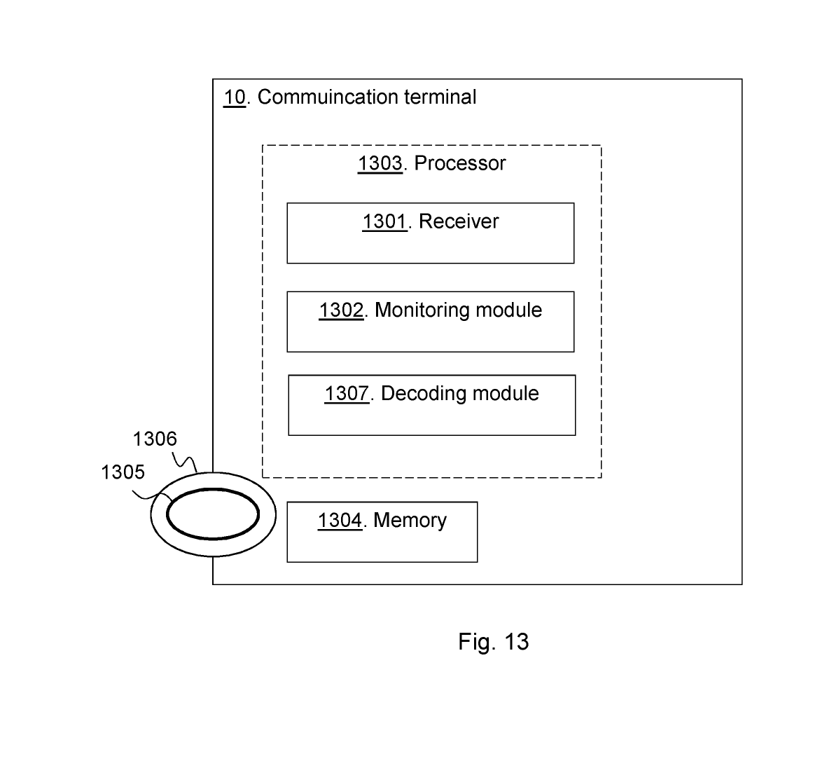

FIG. 13 is a block diagram depicting the communication terminal 10 for handling communication in the wireless communication network 1 according to embodiments herein. The communication terminal 10 is configured to communicate with the radio access node in the first cell 11 of the licensed or unlicensed spectrum and/or the second cell 14 of the unlicensed spectrum.

The communication terminal 10 is configured to receive a configuration from the radio access node, which configuration defines that the communication terminal 10 is to monitor at least two start positions for a control channel intended for the communication terminal 10. The communication terminal 10 may be configured to receive configuration with at least two different sets of PQI values, e.g. be configured to receive a setup configuration from the radio access node for configuring the communication terminal with at least two different sets of PQI values, each indicating a start position of the data channel. The communication terminal 10 may be configured to receive from the radio access node, the indication indicating which set of PQI values to use for determining a start position of the data channel. E.g. control information may comprise an indication indicating the start position for the data channel based on one of the at least two sets of PQI values.

The communication terminal 10 is further configured to monitor the at least two start positions for reception of the control channel. Furthermore, the communication terminal 10 may be configured to monitor the start position for reception of a data channel in a subframe.

In addition, the communication terminal 10 may be configured to detect and decode the data channel. The communication terminal 10 may also be configured to detect and decode the control channel.

Thus, the communication terminal 10 is configured to communicate with a radio access node in the first cell 11 e.g. a primary cell, and/or the second cell 14, e.g. a secondary cell. The radio access node may schedule the communication terminal 10 in a cross carrier manner, e.g. the communication terminal 10 may be configured to be scheduled, from the radio access node, for transmissions also for a cell controlled by a different radio access node or the same radio access node.

The communication terminal 10 may be configured, by comprising a receiver 1301, to receive configuration from the radio access node such as the second radio access node 13 for configuring sets or states of PQI values to use. E.g. the communication terminal 10 may be configured with at least two different sets of PQI values and the radio access node may indicate which one to use.

The communication terminal 10 and/or the receiver 1301 may be configured to receive configuration defining that the communication terminal 10 is to monitor at least two start symbols or positions for control channel intended to the communication terminal 10.

The communication terminal 10 may be configured, by comprising a monitoring module 1302, to monitor, as configured, the at least two start symbols for the control channel, PDCCH or EPDCCH, e.g. during an on-going communication. The communication terminal 10 and/or the monitoring module 1302 may be configured to also or alternatively monitor data over PDSCH starting in the position in the subframe as configured or indicated by the PQI value.

The embodiments herein for scheduling the control channel and/or the data channel may be implemented through one or more processors 1303 in the communication terminal 10 depicted in FIG. 13, e.g. together with computer program code, which processors 1303 or processing means is configured to perform the functions and/or method actions of the embodiments herein.

The receiver 1301 and/or the processor 1303 may be configured to receive a configuration from the radio access node, which configuration defines that the communication terminal 10 is to monitor at least two start positions for a control channel intended for the communication terminal 10. The receiver 1301 and/or the processor 1303 may e.g. be configured to configure the communication terminal with at least two different sets of PQI values. The receiver 1301 and/or the processor 1303 may be configured to receive from the radio access node, the indication indicating which set of PQI values to use for determining a start position of the data channel. E.g. control information may comprise an indication indicating the start position for the data channel based on one of the at least two sets of PQI values.

The monitoring module 1302 and/or the processor 1303 may further be configured to monitor the at least two start positions for reception of the control channel. Furthermore, the communication terminal 10 may be configured to monitor the position for reception of a data channel in a subframe.

Furthermore, the communication terminal 10 may comprise a decoding module 1307. The monitoring module 1302 and/or the processor 1303 may be configured to monitor the at least two start positions for reception of the control channel. Furthermore, the monitoring module 1302 and/or the processor 1303 may be configured to monitor the start position for reception of a data channel in a subframe.

The communication terminal 10 further comprises a memory 1304. The memory comprises one or more units to be used to store data on, such as DCI information, PQI information, applications to perform the methods disclosed herein when being executed, and similar.

The methods according to the embodiments described herein for the communication terminal 10 may be implemented by means of e.g. a computer program 1305 or a computer program product, comprising instructions, i.e., software code portions, which, when executed on at least one processor, cause the at least one processor to carry out the actions described herein, as performed by the communication terminal 10. The computer program 1305 may be stored on a computer-readable storage medium 1306, e.g. a disc or similar. The computer-readable storage medium 1306, having stored thereon the computer program 1305, may comprise the instructions which, when executed on at least one processor, cause the at least one processor to carry out the actions described herein, as performed by the communication terminal 10. In some embodiments, the computer-readable storage medium 1306 may be a non-transitory computer-readable storage medium.

As will be readily understood by those familiar with communications design, functions, means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a communication terminal or radio access node, for example.

Alternatively, several of the functional elements of the processor or processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communication terminals and radio access nodes will appreciate the cost, performance, and maintenance trade-offs inherent in these design choices.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a radio access node for scheduling a control channel and/or a data channel to a communication terminal in a wireless communication network (1); wherein the radio access node (12,13) serves the communication terminal (10) in at least one of a first cell on a carrier of a licensed or unlicensed spectrum, and/or a second cell on a carrier of an unlicensed spectrum, comprising:
determining (702) whether a Listen Before Talk, LBT, process is to be performed or not in the second cell (14);
scheduling (703), based on whether the LBT process is to be performed in a subframe on the second cell or not, a control channel and/or a data channel with a start position in the subframe out of at least two start positions; and
transmitting (704) control information on the control channel and/or data on the data channel as scheduled to the communication terminal (10).

2. A method according to claim 1, further comprising
configuring (701) the communication terminal (10) with a configuration, which configuration defines that the communication terminal (10) is to monitor at least two start positions for the control channel intended for the communication terminal (10).

3. A method according to claim 2, wherein the configuring (701) the communication terminal (10) with at least two different sets of Physical Downlink Shared Channel Resource Element Mapping and Quasi Co-Located Indicator, PQI, values.

4. A method according to claim 3, wherein the transmitting (704) the control information comprising an indication indicating the start position for the data channel based on one of the at least two sets of PQI values.

5. A method according to any of the claims 1-4, wherein the scheduling (703) the control channel and/or data channel intended for the communication terminal (10) comprises scheduling transmission of data on the data channel on the second cell in a cross carrier manner from the first cell.

6. A method according to any of the claims 1-5, wherein the scheduling (703) the start position in the subframe out of at least two start positions comprises scheduling the data channel at an earlier start position than the control channel.

7. A method according to any of the claims 1-6, wherein the control channel is one out of at least two control channels, and wherein the at least two start positions correspond to the at least two control channels such that one of the at least two control channels corresponds to a start position later in the subframe to be scheduled when the LBT process is to be performed and another one of the at least two control channels corresponds to a start position earlier in the subframe to be scheduled when no LBT process is to be performed.

8. A method according to claim 7, wherein the control channel is of an enhanced Physical Downlink Control Channel set that contains a common search space, and uses a start position that allows for LBT.

9. A method according to any of claims 7-8, wherein each control channel out of the at least two control channels is associated with one of a configured Physical Downlink Shared Channel Resource Element Mapping and Quasi Co-Located Indicator state which each include a parameter, pdsch-Start-r11, giving the start position of the control channel.

10. A method performed by a communication terminal (10) for handling communication in a wireless communication network (1), wherein the communication terminal (10) is configured to communicate with a radio access node (13) in a first cell (11) on a carrier of a licensed or unlicensed spectrum and/or a second cell on a carrier of an unlicensed spectrum, comprising
receiving (711) a configuration from the radio access node, which configuration defines that the communication terminal (10) is to monitor at least two start positions for a control channel intended for the communication terminal (10), and
monitoring (713) the at least two start positions for reception of the control channel.

11. A method according to claim 10, wherein the receiving the configuration comprises receiving configuration with at least two different sets of Physical Downlink Shared Channel Resource Element Mapping and Quasi Co-Located Indicator, PQI, values.

12. A method according to claim 11, further comprising
receiving (712) from the radio access node, an indication indicating which set of PQI values to use for determining a start position of a data channel; and
monitoring (714) the start position for reception of the data channel in a subframe.

13. The method according to claim 12, further comprising
detecting and decoding (715) the data channel.

14. The method according to any of the claims 10-13, further comprising
detecting and decoding (716) the control channel.

15. A radio access node (12,13) for scheduling a control channel and/or a data channel to a communication terminal (10) in a wireless communication network (1); wherein the radio access node (12,13) is configured to serve the communication terminal (10) in at least one of a first cell on a carrier of a licensed or unlicensed spectrum, and/or a second cell on a carrier of an unlicensed spectrum, the radio access node being configured to:
determine whether a Listen Before Talk, LBT, process is to be performed or not in the second cell (14);
schedule, based on whether the LBT process is to be performed in a subframe on the second cell or not, a control channel and/or a data channel with a start position in the subframe out of at least two start positions; and
to transmit control information on the control channel and/or data on the data channel as scheduled to the communication terminal (10).

16. A communication terminal (10) for handling communication in a wireless communication network (1), wherein the communication terminal (10) is configured to communicate with a radio access node (13) in a first cell (11) on a carrier of a licensed or unlicensed spectrum and/or a second cell on a carrier of an unlicensed spectrum, the communication terminal (10) being configured to
receive a configuration from the radio access node, which configuration defines that the communication terminal (10) is to monitor at least two start positions for a control channel intended for the communication terminal (10), and to
monitor the at least two start positions for reception of the control channel.
